(19) United States
(12) Patent Application Publication
(10) Pub. No.: US 2008/0060705 A1
(43) Pub. Date: Mar. 13, 2008

(54) FILL VALVE

(75) Inventors: Jamie L. Quinlan, Indian Trail, NC (US); William E. Black, Charlotte, NC (US); Brian K. Gantz, Indian Trail, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: CONBRACO INDUSTRIES, INC., Matthews, NC (US)

(21) Appl. No.: 11/851,635

(22) Filed: Sep. 7, 2007

Related U.S. Application Data
(60) Provisional application No. 60/824,978, filed on Sep. 8, 2006.

(51) Int. Cl. F16K 31/11

(52) U.S. Cl. 137/386

(57) ABSTRACT

A fill valve includes a stand pipe for positioning upright on the floor of a fluid reservoir, and a discharge tube secured at a selected position on the stand pipe by a locking collar. The discharge tube is adapted to move along the stand pipe to allow for height adjustment of the fill valve. A cap is positioned on and engages an end of the discharge tube to house a seating diaphragm, a stem, and a guide ring. The cap uses a snap-on feature that allows for extended fill height adjustment. A float is positioned around the discharge tube and is adapted to move along the discharge tube as the fluid level in the reservoir changes. The discharge tube includes a refill tube connection for filling the reservoir, and a connection for a thermal expansion device to be connected to an interior of the stand pipe.

This application claims priority to U.S. Provisional Patent Application No. 60/824,978, filed Sep. 8, 2006.

### TECHNICAL FIELD AND BACKGROUND OF THE INVENTION

The present invention relates to the field of fluid piping and valves. One particular embodiment of the invention relates to an anti-siphon flush fill valve for toilet tank assemblies.

Flush fill valves are well known and in common usage. Prior art flush fill valves typically use either a ball float connected to a lever arm assembly or a float reciprocally mounted to the stand pipe for actuation of a diaphragm in the fill valve when the fluid level in the tank of the toilet drops below a predetermined level. When the fluid level is at a proper level, the diaphragm is actuated to shut off fluid flow into the tank. More recent fill valve assemblies are provided with adjustable fill tubes to optimize the height of the fill valve based on the tank it is being used with. For example, U.S. Pat. No. 6,199,581 discloses a fill valve with an adjustable stand pipe. This optimized height aids in the prevention of back siphoning through the valve.

In addition to controlling the fluid level in a tank, fill valves may be used to relieve pressure build-up in a closed water system caused by hot water tanks. For example, U.S. Pat. No. 4,745,945 discloses a thermal expansion relief arrangement for plumbing systems. The arrangement uses a pressure relief valve in combination with a fill valve having a ball float connected by a lever arm assembly. However, thermal expansion valves have not been utilized in combination with fill valves that provide height adjustment or floats reciprocally mounted to a pipe stand. This limits thermal expansion protection in tanks having sizes incapable of using a ball float-type fill valve.

### SUMMARY OF THE INVENTION

Therefore it is an object of the invention to provide a fill valve for use with various sized tanks.

It is another object of the invention to provide a fill valve that has an adjustable stand pipe.

It is another object of the invention to provide a fill valve that has a thermal expansion device to relieve pressure build-up in a closed water system.

It is another object of the invention to provide a fill valve that has a float mounted for movement along a stand pipe.

### BRIEF DESCRIPTION OF THE DRAWINGS

The invention may be best understood by reference to the following description in conjunction with the accompanying drawing figures in which:

FIG. 1 is a cross-sectional view of a fill valve according to an embodiment of the invention; and

FIG. 2 is a cross-sectional view of the fill valve of FIG. 1 at a different plane.

### DESCRIPTION OF THE PREFERRED EMBODIMENT AND BEST MODE

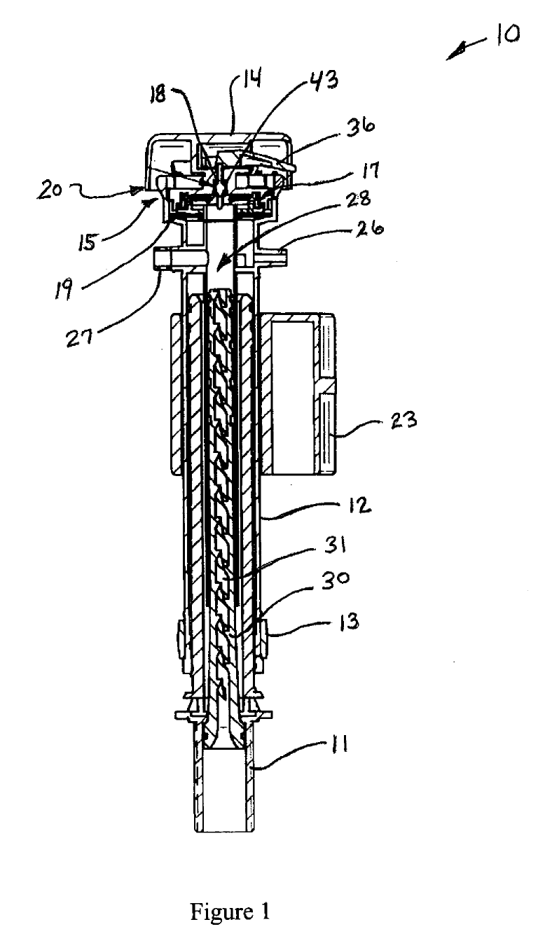

Referring now specifically to the drawings, a fill valve according to an embodiment of the invention is illustrated in FIG. 1 and shown generally at reference numeral 10. The fill valve 10 includes a stand pipe 11 for being secured in a floor of a tank, a discharge tube 12 positioned over the stand pipe 11 and secured in a selected position on the stand pipe 11 by a locking collar 13. The discharge tube 12 is adapted to move along the stand pipe 11 to allow for height adjustment of the fill valve 10. A cap 14 is positioned on and engages an end 15 of the discharge tube 12 to house a seating diaphragm 17, a stem 18, and a guide ring 19. The cap 14 uses a snap-on feature 20 that allows for extended fill height adjustment. A float 23 is positioned around the discharge tube 12 and is adapted to move along the discharge tube 12 as the fluid level in the tank increases or decreases.

The discharge tube 12 includes a refill tube connection 26 for filling the tank with a fluid and a thermal expansion device connection 27 for allowing a thermal expansion device (not shown) to be connected to an interior 28 of the stand pipe 11. The thermal expansion device connection 27 does not interfere with the fill valve's 10 normal operation and provides protection to a closed system by allowing excessive pressure in the closed system to be released through the thermal expansion device.

An anti-siphon tube 30 is positioned within the interior 28 of the stand pipe 11 to prevent siphoning from the tank back into the refill tube connection 26. The stand pipe 11 and anti-siphon tube 30 use a dual seal design to provide a secondary sealing area. The anti-siphon tube 30 includes a pattern of grooves 31, similar to “rifling” to provide an internal flow control that controls the fluid flow and acceleration, thereby reducing noise associated with filling the tank and increasing fill speed.

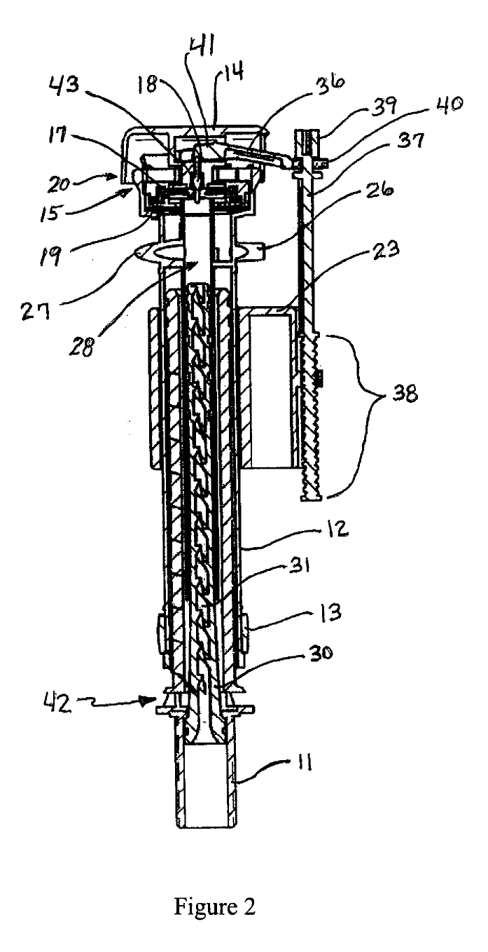

Referring to FIG. 2, an arm 36 is operably connected to the stem 18 to actuate the stem 18 in response to movement of the float 23. The arm 36 is operably connected to the float 23 by an adjustment member 37 that allows the distance between the arm 36 and the float 23 to be increased or decreased. This allows the fluid level in the tank to be adjusted. As shown, the adjustment member 37 is threaded on one end for engaging the float 23 and providing an adjustment zone 38. The adjustment member 37 also includes a “knob-style” post 39 operably connected to the arm 36 on an opposite end that extends past the arm 36 to allow the adjustment member 37 to be rotated by hand to adjust the distance between the float 23 and the arm 36.

In operation, when a toilet is flushed, fluid within the tank is released, causing the float 23 to move downwardly along the discharge tube 12 towards the floor of the tank. When the float 23 moves towards the floor, the float 23 pulls the adjustment member 37, causing the arm 36 to pivot, such that a first end 40 of the arm 36 moves downwardly with the adjustment member 37 and a second end 41 moves upwardly to allow the stem 18 to move from a closed position to an open position. This allows fluid to enter the discharge tube 12 through the refill tube connection 26. The fluid is then directed past the stem 18 and into the interior 28 of the stand pipe 11. The fluid moves through the interior 28 of the stand pipe 11 to an exit 42 to fill the tank.

As the tank begins to fill with fluid, the float 23 moves upwardly along the discharge tube 12, causing the adjustment member 37 to push the first end 40 of the arm 30 upwardly, thereby moving the second end 41 downwardly to move the stem 18 from the open position to the closed position. Once the stem 18 is moved to the closed position, a seal 43 of the stem 18 engages the seating diaphragm 17 to provide a seal and prevent fluid from entering the refill tube connection 26.

While in the closed position, if pressure builds-up in the closed system, the pressure is released through the thermal expansion device connection 27 by the thermal expansion device. Thus, excess pressure can be removed from the closed system through the fill valve 10 to prevent damage to the closed system.

A fill valve and a method of using same is described above. Various details of the invention may be changed without departing from its scope. Furthermore, the foregoing description of the preferred embodiments of the invention and best mode for practicing the invention are provided for the purpose of illustration only and not for the purpose of limitation—the invention being defined by the claims.

What is claimed is:

1. A fill valve for regulating fluid level in a fluid reservoir, comprising:
(a) a stand pipe for being positioned on a floor of the reservoir;
(b) a discharge tube positioned over the stand pipe, and adapted to move along the stand pipe to allow for height adjustment of the fill valve; and
(c) a snap-on cap positioned on an end of the discharge tube to provide extended fill height adjustment.

2. A fill valve according to claim 1, further comprising a locking collar for securing the discharge tube at a selected position on the stand pipe.
